(19) United States
(12) Patent Application Publication
(10) Pub. No.: US 2002/0176565 A1
(43) Pub. Date: Nov. 28, 2002

(54) Method of telephone number dialing based on biometric information

(76) Inventors: Anne Decrouy, Hull (CA); Larry Hamid, Ottawa (CA); Gordon Freedman, Nepean (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 09/863,320

(22) Filed: May 24, 2001

(51) Int. Cl. H04M 1/00; H04M 3/00

(52) U.S. Cl. 379/355.01

(57) ABSTRACT

A telephone is provided with a biometric input sensor for receiving a biometric input. The telephone also includes memory for storing a plurality of phone numbers each associated with unique biometric information template. A comparator compares the biometric input to stored biometric templates in a database. Upon finding a match between the biometric input and the stored biometric templates an associated telephone number is provided to the telephone for dialing.

### FIELD OF THE INVENTION

This invention relates generally to telephones and more particularly to a telephone system provided with a contact-imaging sensor for the automatic dialing of a telephone number in dependence upon information provided to the contact-imaging sensor.

### BACKGROUND OF THE INVENTION

In the past telephones were provided with limited features for inputting data. In order to dial a telephone number a keypad was used. Then came additional features such as speed dial, where a telephone number is stored within a non-volatile memory assigned to speed dial hot-keys. Depressing one of the speed dial hot-keys results in automatic dialing of the stored number, thereby requiring the user to press one key and obviating a need for keeping frequently accessed telephone numbers memorized.

Speed dial is provided as one of the many features on modem telephone systems, found either at the office or at home. The telephone numbers of these frequently called contacts are typically stored in memory within the speed dial of the telephone system. Because these contacts are so frequently called they are typically the most important telephone numbers for a user. Of course, they may also be numbers that are difficult to remember or long and difficult to dial. In the case of an office telephone system, speed dial buttons may include numbers to home, personal cell phones, or to other family members, which the user does not wish to have available to anyone else who uses their telephone system. On current telephone systems anyone wishing to utilize a speed dial feature on a telephone can do so without any security option and, as such, personal telephone numbers are often available to unauthorized parties.

In U.S. Pat. No. 5,872,834 in the name of Teitelbaum a telephone system is described where provided on the telephone is a biometric input sensor. The user identifies themselves through this sensor for the purposes of transmitting the user's identity information to a further other system, for instance for the purpose of billing information or for the purpose of logging the user identity, or for the purpose of telephone security.

It is clear from a careful review of the prior art, that the use of fingerprints is analogous to entering a personal identification number (PIN). It is used to identify an individual user of a telephone or another device. The use of a PIN is well known in the art of security for electronic systems.

Once a contact-imaging sensor is provided with a telephone system, it would be advantageous to provide other uses for biometric information provided to a telephone system in order to expand system functionality.

### OBJECT OF THE INVENTION

It is therefore the scope of this invention to provide storage and access of telephone numbers within a telephone system such that retrieving and dialing of a telephone number is performed in response to biometric information provided by a user.

### SUMMARY OF THE INVENTION

In accordance with the invention there is provided a method of performing a speed-dial operation on a telephone system comprising stored biometric templates. The method comprises the steps of: providing biometric information to a contact imaging device for providing to the telephone system biometric data in response to the provided biometric information; processing the biometric data to determine a biometric template of the stored biometric templates that corresponds to the biometric data within predetermined limits; and, automatically dialing a telephone number associated with the determined biometric template.

In accordance with another embodiment of the invention there is provided a method of performing a speed-dial operation on a telephone system forming part of a telephone network comprising a database for storing biometric templates. The method comprises the steps of: providing biometric information to a contact imaging device in communication with the network for providing biometric data in response to the provided biometric information; processing the biometric data with a processor to determine a biometric template that corresponds to the biometric data within predetermined limits; retrieving from the database a telephone number associated with the biometric template; and, automatically, dialing the retrieved telephone number.

It is advantageous to provide a telephone with a biometric input device for identifying a fingertip print of a user and to dial a known telephone number correlated to the fingertip information as security is provided as is ease of use because the stored templates are unique only to the fingertips of the user.

### BRIEF DESCRIPTION OF THE DRAWINGS

FIG. 1 is a diagram of a telephone system incorporating a contact-imaging sensor, processor and non-volatile memory;

FIG. 2 is a simplified flow diagram of process flow within the telephone system for the automatic dialing of a telephone number;

FIG. 3 is a simplified flow diagram of process flow within the telephone system for the storage of a new telephone number; and,

FIG. 4 shows a block diagram of a telephone network system wherein biometric templates are stored within a central database and a simplified flow diagram of a method for retrieval of a number from the database

### DETAILED DESCRIPTION OF THE INVENTION

According to the invention, a telephone system is provided with a contact-imaging sensor for accepting biometric information and providing biometric data in dependence upon the biometric information. In addition to standard telephone functions the telephone system comprises memory for storing a database and a processor for correlating the biometric information with stored biometric templates. The data stored within the database comprise biometric templates derived from biometric information and associated telephone numbers and/or identifiers therefore. The function of the processor is for comparing input biometric information to stored biometric templates in database, and upon finding a correlation between the biometric information and a biometric template providing of the stored telephone number to the telephone for dialing of the number.

Contact imaging devices are known to include electrical contact imaging sensors such as capacitive fingerprint imagers and optical contact imaging sensors such as optical fingerprint imagers. In use, a user of such a contact-imaging sensor makes physical contact with a component of the sensor.

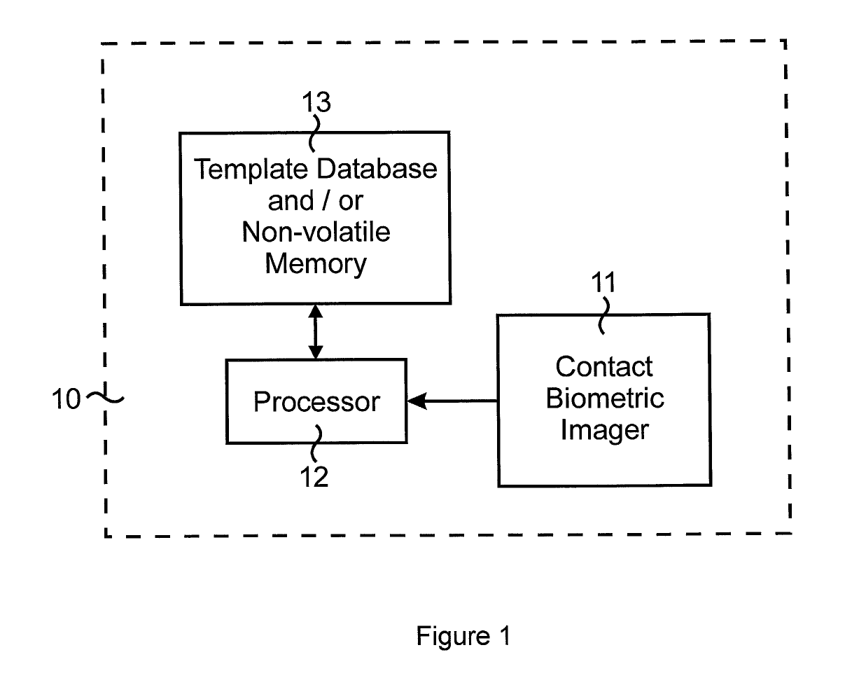

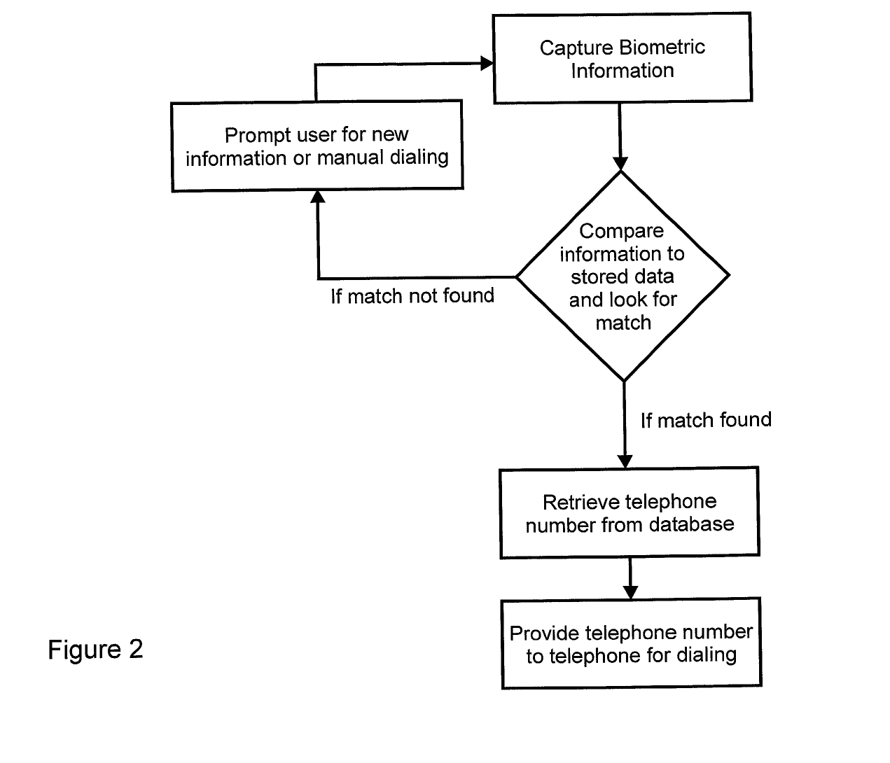

In the exemplary embodiment of FIG. 1 and a the process flow diagram of FIG. 2, a telephone system 10 is provided with a contact-imaging sensor 11 for accepting biometric information and providing biometric data in dependence upon the biometric information. The biometric information is in the form of a fingerprint. A user places a fingertip on the contact-imaging sensor 11 and biometric information is captured. Biometric data in dependence upon the biometric information is provided to a processor 12 in the form of a microprocessor. The microprocessor analyzes the biometric data for identifiable features and compares predetermined features against those of biometric templates stored in a database 13. Fingerprint comparison is well known in the art and any suitable method of registering fingerprints is usable with the present invention. The database comprises a list of biometric templates correlated to telephone numbers. When a match is found between the biometric information and the biometric template the processor retrieves the telephone number associated with the matching biometric template from the database and provides the telephone number to the telephone for automatic dialing.

When no match is found between the biometric information and biometric templates stored in the database no telephone number is retrieved and as such no telephone number is automatically dialed. Optionally the current user is prompted to enter a telephone number.

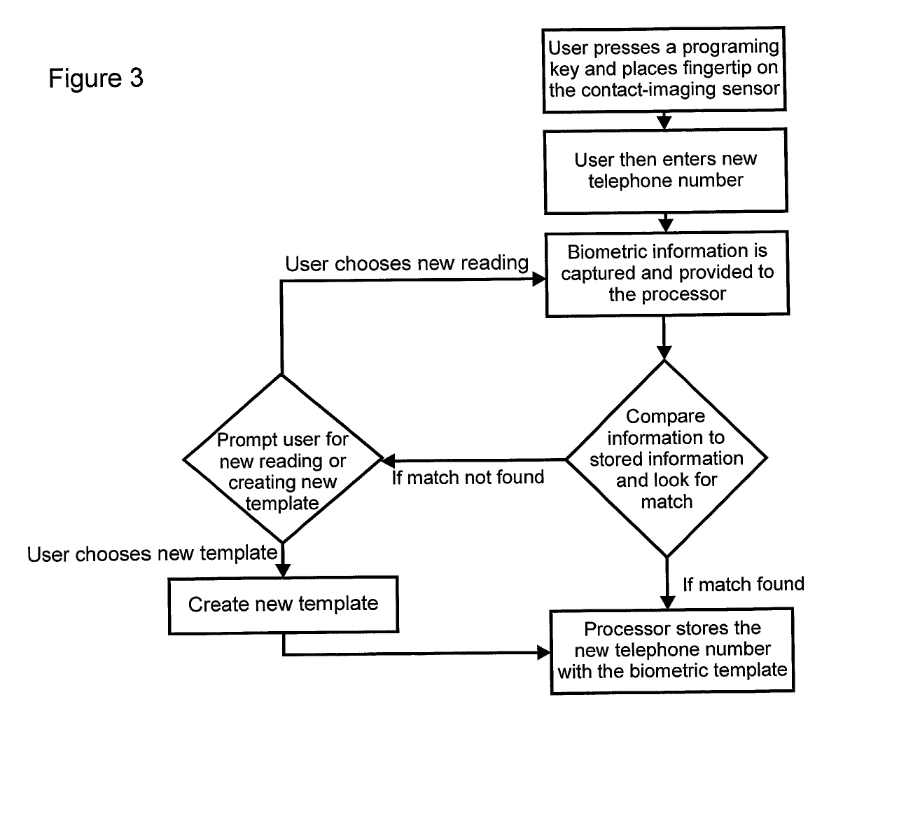

In order to program the system with a new speed-dial telephone number, as is shown in FIG. 3, a user initiates programming for example by pressing a programming key. The user then places a fingertip upon the contact-imaging sensor and enters a new telephone number via the keypad 14 into the telephone system. An image of the fingerprint is captured forming the biometric information. Biometric data in dependence upon the biometric information is provided to a processor 12 in the form of a microprocessor. The microprocessor analyzes the biometric data for identifiable features and compares predetermined features against those of biometric templates stored in a database 13. The database comprises a list of biometric templates each associated with a telephone number. When a match is found between the input biometric information and the biometric template the processor stores the new telephone number associated with the matching biometric template in the database.

When no match is found between the biometric information and biometric templates stored in the database, the processor processes the biometric data to provide a biometric template and stores the biometric template and the new telephone number in the database in association one with the other.

In another embodiment biometric templates are not stored within a telephone but are stored within a database forming part of the telephone network. Advantageously this allows for any individual within an office environment to have access to their personal telephone numbers from any extension connected to the telephone network.

This type of biometric telephone number dialing becomes a very useful feature, for example, in large offices comprising many telephones with each telephone being part of a same telephone network because each individual maintains the same speed dial numbers accessible by providing same biometric information at any of the many telephones connected to the telephone network.

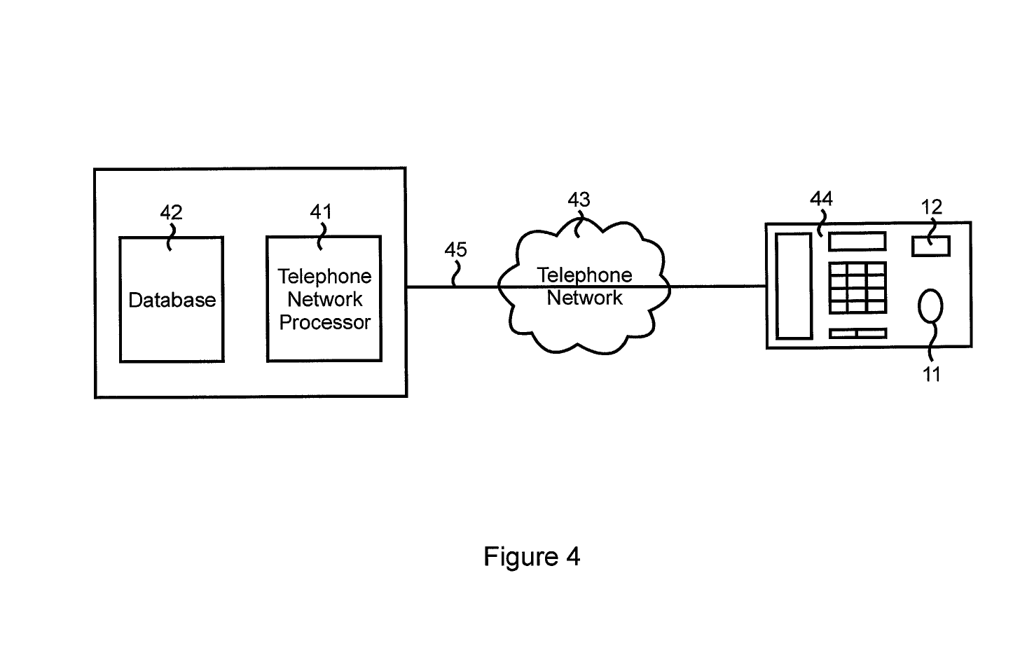

In the embodiment of FIG. 4 a user places a fingertip on the contact-imaging sensor 11 of a telephone 44 as part of the telephone network 43 and biometric information is captured. Biometric data in dependence upon the biometric information is provided to a processor 12 in the form of a microprocessor. The processor transmits the biometric data via telephone network connectivity 45 to a telephone network processor 41. The telephone network processor 41 analyzes the biometric data for identifiable features and compares predetermined features against those of biometric templates stored in a telephone network database 42. The telephone network database 42 comprises a list of biometric templates associated with telephone numbers. When a match is found between the biometric information and the biometric template the processor retrieves the telephone number associated with the matching biometric template from the database and provides the telephone number to the telephone for initiating automatic dialing via telephone network connectivity.

When no match is found between the biometric information and biometric templates stored in the telephone network database no telephone number is retrieved and as such no telephone number is automatically dialed. Optionally the current user is prompted to enter a telephone number.

In order to program the telephone network system with a new speed-dial telephone number, as can also be explained with the aid of FIG. 3, a user initiates programming by pressing a programming key. The user then places a fingertip upon the contact-imaging sensor and enters a new telephone number via the keypad 14 into the telephone system. An image of the fingertip print is captured forming biometric information. Biometric data in dependence upon the biometric information is provided to a processor 12 in the form of a microprocessor. The processor transmits the biometric data via telephone network connectivity to a telephone network processor. The telephone network processor analyzes the biometric data for identifiable features and compares predetermined features against those of biometric templates stored in a telephone network database. The telephone network database comprises a list of biometric templates and associated telephone numbers. When a match is found between the biometric information and the biometric template the telephone network processor stores the new telephone number associated with the matching biometric template from the telephone network database.

When no match is found between the biometric information and biometric templates stored in the telephone network database, the telephone network processor processes the biometric data to provide a biometric template and stores the biometric template and the new telephone number in the telephone network database and associated one with the other.

Alternatively, an associated telephone number, once retrieved, is not provided to the telephone by the processor. Instead the processor has the capacity for generation of tones and the number is dialed by a step of generating a series of tones.

Alternatively, when an associated telephone number is provided to the telephone from the processor, the user is prompted to accept the telephone number prior to initiation of dialing of the number.

In another embodiment the redial feature on a telephone is also responsive to biometric information. The telephone system comprises a contact-imaging sensor as part of a redial feature on a telephone. When a user places their finger on the contact imaging sensor of the redial key of the telephone, the biometric information is sensed and biometric data is provided in dependence thereon to the processor. The processor compares the biometric data with biometric templates stored within the database along with the corresponding redial number. After finding a match between the biometric information and the biometric template, the processor redials the corresponding telephone number. In a telephone network system any user placing their finger-tip upon the contact imaging sensor of any telephone network connected telephone will result in their last number dialed being provided to the telephone for dialing.

Of course, it is also possible to merely associate each fingertip with a number in order to use the present invention with existing systems. For example, providing an index finger results in dialing of those keys necessary to initiate a speed-dial 1 operation and providing a ring finger results in dialing of those keys necessary to initiate a speed-dial 3 operation.

Alternatively in another embodiment, the invention is applicable to feature selection on remote control devices. A remote control for an entertainment system requires independent control of all devices connected to the entertainment system, for example TV, VCR, Stereo, and DVD. In order to use a single remote for each of these devices switches are provided on prior art controllers such that features on the remote control device address each of the controllable devices independently. It would be associated with each device a different fingerprint of a user such that the fingertip biometric information facilitates the changing from one device to another.

In this embodiment a remote control system is provided with a contact-imaging sensor for accepting a biometric input and providing biometric data in dependence upon the biometric information. The biometric input information is in the form of a fingerprint. A user places a fingertip on the contact-imaging sensor and biometric information is captured. Biometric data in dependence upon the biometric information is provided to a processor in the form of a microprocessor. The microprocessor analyzes the biometric data for identifiable features and compares predetermined features against those of biometric templates stored in a database. The database comprises a list of biometric templates correlated to home entertainment device control codes. When a match is found between the biometric information and the biometric template the processor retrieves the appropriate home entertainment device codes associated with the matching biometric template from the database and provides the home entertainment device codes to the remote control for assigning remote control features to the selected home entertainment device. Therefore the need for flipping a switch to change between home entertainment devices, or depressing buttons for device selection would be obviated. Advantageously different users can assign their own remote control features for controlling home entertainment devices to personal biometric information. Alternatively, the remote control device already has codes associated with each device to be controlled and identification of biometric information source is used to select which codes to use.

Numerous other embodiments may be envisaged without departing from the spirit and scope of the invention.

What is claimed is:

1. A method of performing a speed-dial operation on a telephone system, the method comprising the steps of:
providing biometric information to a contact imaging device for providing to the telephone system biometric data in response to the provided biometric information;
processing the biometric data to automatically determine a telephone number associated with the provided biometric information; and,
automatically dialing the determined telephone number.

2. A method of performing a speed-dial operation on a telephone system, wherein the telephone system comprises stored biometric templates and wherein the step of determining a telephone number comprises the steps of:
processing the biometric data to determine a biometric template of the stored biometric templates that corresponds to the biometric data within predetermined limits; and,
determining the telephone number associated with the determined biometric template.

3. A method of performing a speed-dial operation on a telephone system according to claim 2, comprising the step of:
receiving biometric information from a biometric information source other than a biometric information source for which a template is stored;
receiving a telephone number for storage; and
storing a biometric template derived from the biometric information and a telephone number associated therewith.

4. A method of performing a speed-dial operation on a telephone system according to claim 3, further comprising the step of:
upon determining a corresponding biometric template, retrieving a telephone number associated with the corresponding biometric template; and
providing the telephone number to the telephone system for dialing.

5. An auto-dialer comprising:
memory for storing at least a database including data relating to biometric templates and telephone numbers and an association therebetween;
a contact-imaging sensor for receiving biometric information; and,
a processor for comparing the biometric information to stored biometric templates in order to determine a substantial match and for providing a telephone number associated with the biometric template with which the biometric information matches to a system for dialing the provided telephone number.

6. A telephone system according to claim 5, wherein the contact imaging sensor is for sensing fingertip prints.

7. A telephone system according to claim 5, comprising a numeric keypad, wherein the database is additionally for receiving and storing biometric templates and a telephone number entered via the numeric keypad in association therewith.

8. An auto dialer according to claim 5, wherein the database includes sufficient memory for storing each of a plurality of biometric templates and an associated telephone number for each.

9. An auto dialer according to claim 1, wherein the database includes a table having a biometric template and a single telephone number associated therewith.

10. An auto dialer according to claim 9, wherein the database includes a list of recently dialed phone numbers and an associated individual wherein, the individual is provided with their most recently dialed number upon being identified.

11. An auto dialer according to claim 1, comprising a redial button including a contact imaging sensor wherein provision of different fingertips to the redial button results in dialing of different recently dialed telephone numbers.

12. An auto dialer according to claim 11, wherein the database comprises entries for each of a plurality of recently dialed telephone numbers and an association with an individual who dialed them.

13. A method of performing a speed-dial operation on a telephone system forming part of a telephone network comprising a database for storing biometric templates, the method comprising the steps of:
providing biometric information to a contact imaging device in communication with the network for providing biometric data in response to the provided biometric information;
processing the biometric data with a processor to determine a biometric template that corresponds to the biometric data within predetermined limits;
retrieving from the database a telephone number associated with the biometric template; and,
automatically, dialing the retrieved telephone number.

14. A method of performing a speed-dial operation on a telephone system forming part of a telephone network according to claim 13, comprising the step of transmitting received biometric data to the processor, the processor co-located with a storage device for storing the database.

15. A method of performing a speed-dial operation on a telephone system forming part of a telephone network according to claim 14, wherein the step of transmitting received biometric data to the processor, is a same step on each of a plurality of locations within the network, and wherein the processor is a central processor for processing biometric data transmitted from each of the plurality of locations.

16. A method of performing an operation on any of a plurality of devices controlled via a same controller comprising the steps of:
providing biometric information to a contact imaging device in communication with the network for providing biometric data in response to the provided biometric information;
processing the biometric data with a processor to determine a device from the plurality of devices with which the template is associated; and,
providing a control signal to the associated device for controlling a function thereof.

17. A method of performing a speed-dial operation on a telephone system, wherein the telephone system comprises stored biometric templates and wherein the step of processing the biometric data comprises the steps of:
processing the biometric data to determine a biometric template of the stored biometric templates that corresponds to the biometric data within predetermined limits; and,
determining the device associated with the determined biometric template.

18. A method of performing an operation on any of a plurality of devices controlled via a same controller as defined in claim 16, comprising the steps of providing a control function and wherein the control signal is indicative of the control function.

19. A method of performing an operation on any of a plurality of devices controlled via a same controller as defined in claim 18, wherein the controller is a wireless controller and wherein the control signal is a wireless control signal for the associated device for performing the control function.

20. An auto-dialer comprising:
memory for storing at least a database including data relating to biometric templates and telephone numbers and an association therebetween;
a contact-imaging sensor for receiving biometric information; and,
a processor for analysing the biometric information in order to determine a telephone number associated with the biometric information and for providing the telephone number to a system for dialing the provided telephone number.
